(19) United States
(12) Patent Application Publication
(10) Pub. No.: US 2008/0083034 A1
(43) Pub. Date: Apr. 3, 2008

(54) ATTACK CLASSIFICATION METHOD FOR COMPUTER NETWORK SECURITY

(76) Inventors: Dae Won KIM, Daejeon (KR); Yang Seo CHOI, Daejeon (KR); Ik Kyun KIM, Daejeon (KR); Jin Tae OH, Daejeon (KR); Jong Soo JANG, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/757,701

(22) Filed: Jun. 4, 2007

(30) Foreign Application Priority Data
Sep. 29, 2006 (KR) 10-2006-96425

(51) Int. Cl. G08B 23/00

(52) U.S. Cl. 726/25

(57) ABSTRACT

Provided is an attack classification method for computer network security. In the attack classification method, attacks are classified depending on vulnerability abused by an attack, attack propagation skills, and attack intentions. The classification results are arranged in the order of the vulnerability abused by an attack, the attack propagation skills, and the attack intentions. The arranged classification results are output. Accordingly, it is possible to easily detect an attack flow where an attack A propagates in the propagation skill C using the vulnerability B and the attack skill F is used for the attack target E to achieve the attack purpose D.

### CLAIM OF PRIORITY

This application claims the benefit of Korean Patent Application No. 10-2006-96425 filed on Sep. 29, 2006 in the Korean Intellectual Property Office, the disclosure of which is incorporated herein by reference.

### BACKGROUND OF THE INVENTION

1. Field of the Invention

The present invention relates to computer network security technology, and more particularly, to an attack classification method for computer network security, the use of which makes it possible to easily detect the feature and overall flow of every attack and to easily detect a method and time point for blocking the attack.

2. Description of the Related Art

Nowadays computer network attacks are expanding their influences more and more. Any terminal related to a computer or connected to a network may be attacked by computer viruses, worms and hackers. Such attacks may occur not only in a business related system but also in a personal system. Accordingly, a through research of the attack is strongly required in order to counteract the attack.

For the past few years, the computer network attack has explosively increased and has also evolved into a blended type that is difficult to block in a simple defense skill.

In order to efficiently defend the system against new attacks, it is necessary to detect the features of the attacks and to rapidly provide a defense method suitable therefor. To this end, it is necessary to provide a systematic attack classification method, the use of which makes it possible to easily detect the features and flows of new attacks as well as of the blended type attacks.

The use of a structural classification system for such attacks makes it possible to apply the same classification scheme to new unknown attacks and to provide a standard that enables a security-related organization or a security manager to understand the same attack in the same meaning.

In this regard, there have been proposed a variety of attack classification methods. However, information for detection of the flow of one attack is insufficient in logic and content, most of the conventional attack classification methods fail to facilitate development of a method for counteracting an actual attack. In addition, most of the conventional attack classification methods focus on intuitive attacks or compatibility with the famous conventional classification method and provides only unclear classification purposes and criteria.

There have been proposed other attack classification methods that have clear purposes and structures to solve the above problem. However, these conventional attack classification methods are targeted on specific attacks such as a Denial of Service (DoS) attack and a worm and thus fail to provide a unified classification method for the entire computer network attacks.

For example, Howard has proposed an attack process based classification method that may comprise extensive attacks. The attack process based classification method is configured to comprise five categories of attacker, tool, access, result and purpose. The attack process based classification method is suitable for observation of the entire process of an attack. However, the attack process based classification method does not provide detailed attack features and is thus unsuitable for classification of an attack such as a Code Red worm. Lough has proposed a VERDICT (Validation Exposure Randomness De-allocation Improper Conditions Taxonomy) method based on attack features. The VERDICT method can suitably classify new attacks and blended type attacks based on the attack features. However, because of the unclearness of attack skills and types (worms or viruses), the VERDICT method fails to classify all attacks. Somon has proposed an attack classification method that classifies attacks using four dimensions including an attack vector, an attack target, vulnerability, an attack skill for the vulnerability, a description of the features of blended-type attacks. The attack classification method of Somon can represent attacks in detail. However, due to the too detailed classification of attacks, the attack classification cannot classify a new attack as being similar to the conventional attacks.

Because there is no attack classification method that enables detection of an attack flow while being able to classify all computer network attacks including new unknown attacks, it is impossible to determine the defense range of a corresponding security system for attacks in order to develop the security system. As a result, developers or designers are embarrassed in determining which of many attacks (e.g., viruses, worms, DoS attacks, and spywares) are to be blocked by the corresponding security system.

### SUMMARY OF THE INVENTION

The present invention has been made to solve the foregoing problems of the prior art and therefore an aspect of the present invention is to provide an attack classification method for computer network security, the use of which makes it possible to classify all attacks including new attacks and to provide a united classification system for the computer network security.

Another aspect of the present invention is to provide an attack classification method for computer network security, the use of which makes it possible to provide a united classification system for the computer network security and to provide information about an attack flow using the classification results.

A further aspect of the present invention is to provide an attack classification method for computer network security, the use of which makes it possible to classify network/computer attacks and to group attacks on the basis of purpose and usage depending on the classification results.

A still further another of the present invention is to provide an attack classification method for computer network security, the use of which makes it possible to classify all attacks including new attacks and to easily detect the method and time point for counteracting the attack on the basis of the classification results.

A still further another of the present invention is to provide an attack classification method for computer network security, the use of which makes it possible to define an defendable attack range suitable for a security system using a unified classification system for the computer network security.

According to an aspect of the present invention, an attack classification method for computer network security, the method comprises: receiving data determined to be an attack; classifying the received attack depending on vulnerability abused by an attack; classifying the received attack depending on attack propagation skills; classifying the received attack depending on attack intentions; arranging the classification results in the order of the vulnerability abused by an attack, the attack propagation skills, and the attack intentions; and outputting the arranged classification results.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a flow diagram illustrating an overall process of an attack classification method for computer network security according to an embodiment of the present invention;

FIG. 2 is a flow diagram illustrating three classification domains in the attack classification method according to the present invention;

FIG. 3 is a flow diagram illustrating the arrangement status of the three classification domains in the attack classification method according to the present invention;

FIG. 4 is a detailed flow diagram of a classification step depending on the vulnerability in the attack classification method according to the present invention;

FIG. 5 illustrates the detailed items in the classification step depending on the vulnerability in the attack classification method according to the present invention;

FIG. 6 is a detailed flow diagram of a classification step depending on propagation skills in the attack classification method according to the present invention;

FIG. 7 illustrates the detailed items in the classification step depending on the propagation skills in the attack classification method according to the present invention;

FIG. 8 is a detailed flow diagram of a classification step depending on attack intentions in the attack classification method according to the present invention;

FIG. 9 illustrates the detailed items in the classification step depending on the attack intentions in the attack classification method according to the present invention;

FIG. 10 illustrates an example of classification of a blended type attack according to the attack classification method of the present invention; and

FIG. 11 is an attack flow diagram illustrating the results of classification of spywares according to the attack classification method of the present invention.

### DETAILED DESCRIPTION OF THE PREFERRED EMBODIMENT

Exemplary embodiments of the present invention will now be described in detail with reference to the accompanying drawings.

In the following description of the embodiments of the present invention, detailed descriptions about well-known functions and configurations incorporated herein will be omitted if they are deemed to obscure the subject matter of the present invention. In addition, like reference numerals in the drawings denote like elements.

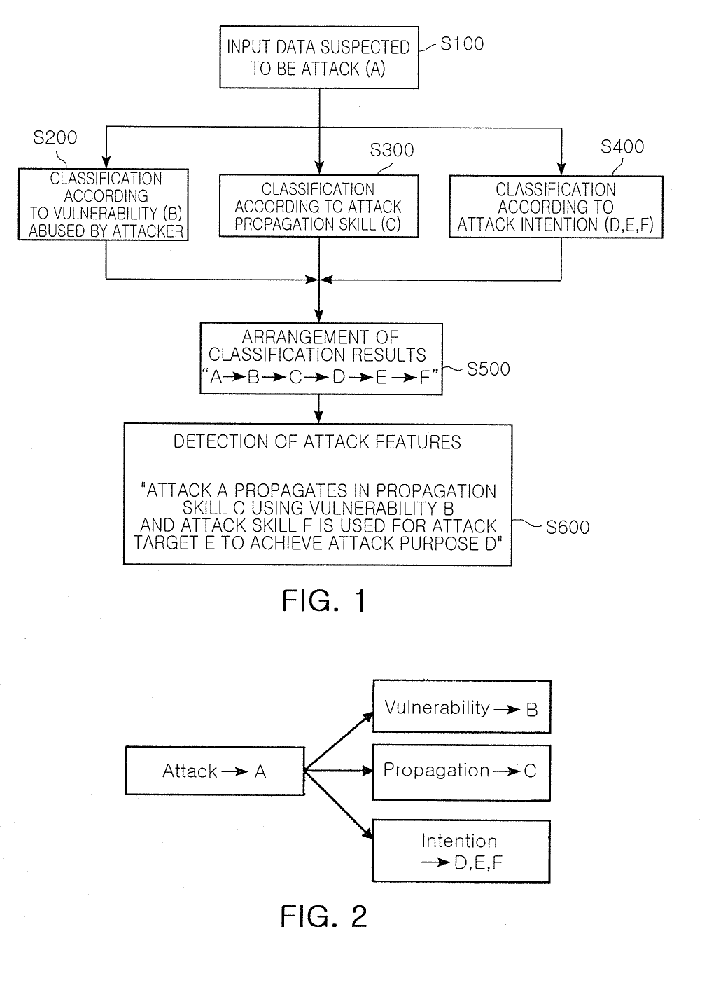

FIG. 1 illustrates an overall process of an attack classification method for computer network security according to an embodiment of the present invention.

Referring to FIG. 1, when data suspected to be an attack (i.e., gathered traffics or files; hereinafter referred to as “attack”) are inputted (S100), the features of the attacks are analyzed and classified in order to be able to interpret the overall phenomenon for attacks. The classification step may comprise the following three domains.

The first domain is a step for classifying attacks depending on vulnerability maliciously used by attackers (S200) The second domain is a step for classifying propagation conditions of attacks (S300). The third domain is a step for classifying attack intentions of attackers (S400). The above three domains are independent of one another, and a blended type attack may have two or more classification results for each domain.

In the classification depending on the vulnerability in the first domain, the vulnerability may be classified into vulnerability in actual implementation, vulnerability due to incorrect configuration, security vulnerability in application design, vulnerability in network protocols, and vulnerability due to lack of security consciousness. Such classified information depending on the vulnerability can be used to group attacks using the same vulnerability and to block the grouped attacks.

The classification depending on the propagation conditions in the second domain describes whether an attack is automated or not. The description about the automation informs a method for selecting and invading a predetermined attack target, a starting method of a malicious action, and an occurring method of an additional attack. This makes it possible to infer a propagation skill of an attack and to detect a method and time point of blocking a propagating attack.

In the classification depending on the attack intentions in the third domain, the attack intentions comprise an attack purpose, an attack target, and an attack skill. In the classification, a phenomenon of actual occurrence of a malicious action can be classified to provide critical information necessary for detecting the detailed features of an attack, wherein the points accruing malicious actions and general malicious results are arranged in detail.

FIG. 2 illustrates the basic concept of the attack classification method according to the present invention. For an attack A, a vulnerability B used by the attack A is detected to perform the classification depending on the vulnerability. A propagation skill C for the attack A is detected to perform the classification depending on the propagation conditions. A purpose D of an attack A, an attack target E, and an attack skill F are detected to perform the classification depending on the attack intentions.

After completion of the attack classification for the above three domains, the classification results are arranged in turn for detection of the total flow of an attack (S500). At this point, the results classified simultaneously in the same domain are arranged in parallel.

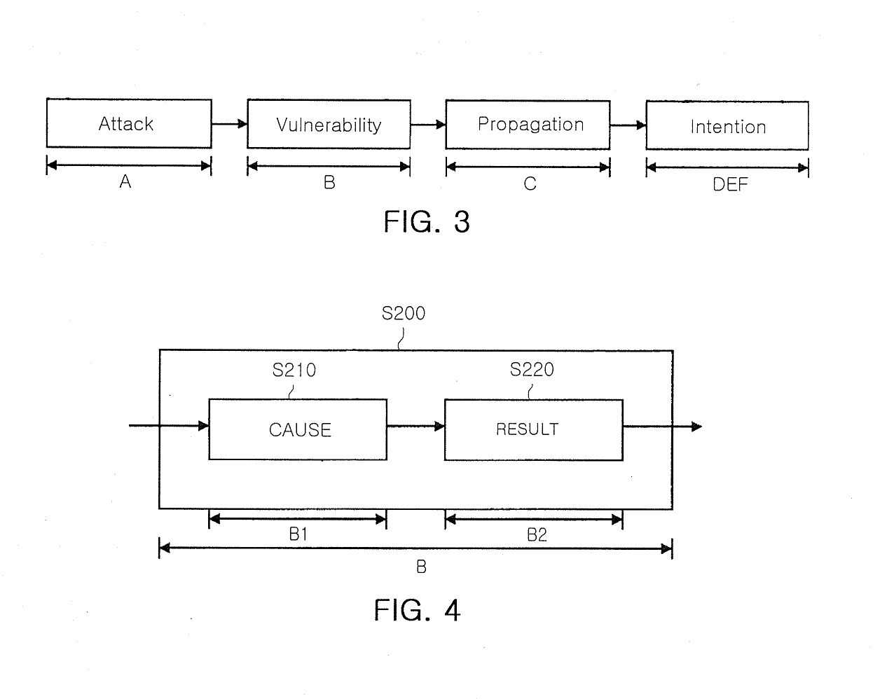

The criterion for arrangement of the classification results reveals the conclusion that “the attack A propagates in the propagation skill C using the vulnerability B and the attack skill F is used for the attack target E to achieve the attack purpose D”. FIG. 3 illustrates the arrangement status of the classification results in S500. The classification results are arranged in the order of “Attack A→Vulnerability B→Propagation C→Object D→Attack Target E→Attack Skill F”. Arrows are used to represent a flow of an attack and the attack flow is detected at a single glance, thereby making it possible to detect an attack point and an attack method.

The feature of the attack is detected using the above classification results (S600).

From the attack flow arranged as above, it is possible to detect the feature and type of the attack A, that is, “the attack A propagates in the propagation skill C using the vulnerability B and the attack skill F is used for the attack target E to achieve the attack purpose D”.

In the attack classification method, each of the classification steps S200, S300 and S400 has a particular classification criterion. The particular classification criterion is equal to one flow capable of representing the attack feature naturally. If an attack uses a single attack skill, it has one flow. On the other hand, a blended type attack has two or more flows.

Hereinafter, the detailed classification criteria and processes in the classification steps S200, S300 and S400 will be described in detail.

FIG. 4 is a detailed flow diagram of the classification step S300 depending on the vulnerability.

The classification step S200 is used to indicate the vulnerability of a target system used by attackers. In general, an attack is impossible without vulnerability. In addition, if there is any vulnerability in even one respect, the entire system may be attacked due to the vulnerability. Therefore, the present invention classifies attacks depending on the vulnerability of an attack target system so that the vulnerability of the attack target system can be corrected after the fact. In addition, the present invention groups attacks with the same vulnerability in order to be able to determine whether the same security policy can be applied to the same attack group and to determine the range of attacks that can be interrupted using a security system.

Referring to FIG. 4, the classification step S200 classifies the vulnerability into a vulnerability cause B1 and an result B2 generating from the vulnerability cause B1 (S210 and S220).

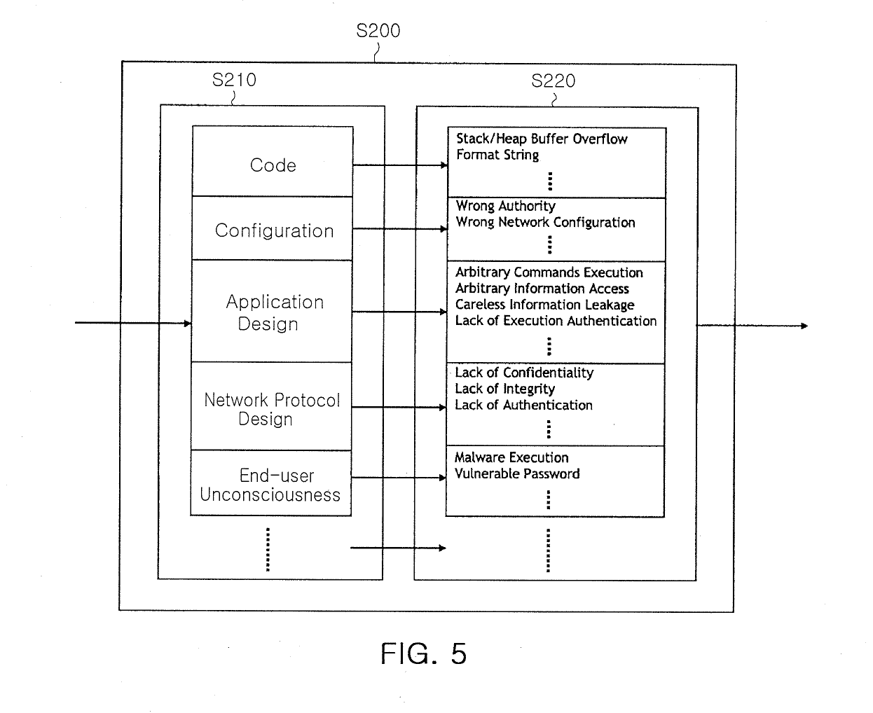

In addition, the present invention classifies a variety of possible vulnerability into five levels, which is illustrated in FIG. 5. The five typical classification levels represent the features of standard attacks, which can be expanded in the event of a new pattern of attack.

Referring to FIG. 5, the vulnerability of an attack target system is classified into code, configuration, application design, network protocol design, and end-user unconsciousness in the cause classification step S210.

The code is vulnerability generated when a vulnerable code is used due to a designer's unconsciousness or mistake. A typical example of a result due to the code vulnerability is a buffer overflow.

The configuration is vulnerability generated when an operating system (OS), an application, and a network structure in a target system is set incorrectly, which may result in incorrect authentication and an incorrect network configuration.

The application design is vulnerability that the execution results of an application program may cause a security problem regardless of whether a function is designed intentionally. This may result in arbitrary command execution, arbitrary information access, careless information leakage, and lack of execution authentication (S220). The arbitrary command execution refers to the arbitrary execution of a shell command without a user's consent. The arbitrary information access refers to the arbitrary access of files or system information without a user's consent. The careless information leakage refers to the careless leakage of important information due to the problem of a program design. The lack of execution authentication refers to the execution of a program without a user's consent.

The network protocol design is vulnerability generated due to the design problem of a network protocol. The vulnerability of the network protocol design results in lack of confidentiality, lack of integrity, and lack of authentication. The lack of confidentiality refers to the leakage of information due to non-encrypted information. The lack of integrity refers to the impossibility of detection of whether normal information is arbitrary changed by an attacker. The lack of authentication is generated because there is no authentication method for confidence in a communication opponent party.

The end-user unconsciousness is vulnerability caused by the lack of a user's security consciousness. The vulnerability due to the end-user unconsciousness results in malware execution and vulnerable password. The malware execution is caused by the lack of consciousness for a malware program such as Trojan and ActiveX. The vulnerable password is generated when a password is not set or an easy password is set.

In the case of a well-known Blaster Worm, the Blaster worm scans and invades an attack target with vulnerability that can be used. The invasion is achieved as the result of a stack buffer overflow of an RPC DCOM program that operates always in the Window OS. The buffer overflow is caused by the vulnerable coding operation of an RPC DCOM designer.

Accordingly, in the classification step S200, the attack of the Blaster worm is classified as an attack that results in a stack buffer overflow due to a vulnerable code.

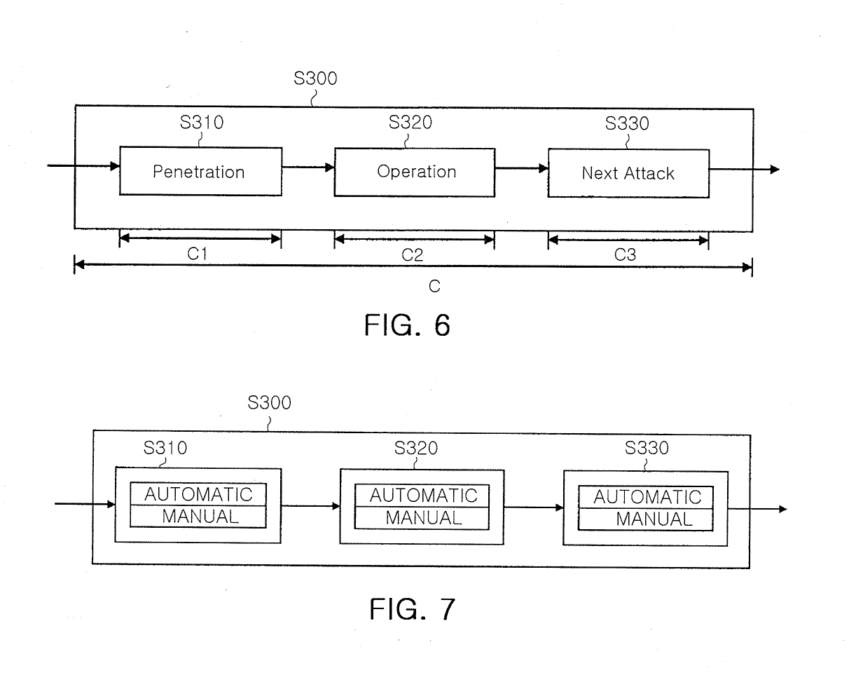

FIG. 6 a detailed flow diagram of the classification step S300 depending on the attack propagation conditions. In general, an attack on a computer or a network is characterized in that it continues to propagate from an attacked target to another attack target.

Accordingly, in the classification step S300, the present invention defines the overall attack propagation process in the order of a penetration step S310 in which the vulnerability of an attack target is used to infect the attack target, an operation step S320 in which an malicious action is executed in the penetrated target, and an next attack step S330 in which a next attack target is selected and penetrated. Thereafter, a corresponding attack is classified depending on whether each of the defined steps is manually executed with the intervention of a user or is automatically executed without the intervention of a user.

FIG. 7 illustrates the detailed items of each propagation step of the classification step S300 illustrated in FIG. 6, which represents whether each of the penetration step S310, the operation step S320 and the next attack step S330 is executed automatically or manually.

For example, in the case of a Blaster worm, when an attacker executes a Blaster worm program, the Blaster worm program searches an attack target that uses an RPC DCOM program vulnerable to Window environments, inserts data for a stack buffer overflow into the RPC DCOM program to infect the attack target, and transports a Blaster code to the attack target.

Accordingly, the Blaster worm itself penetrates the program and the penetrated worm is automatically executed to cause unnecessary network traffic. In addition, while executing a malicious action of changing an Internet Explorer start page into a specific site the Blaster worm, the Blaster worm automatically searches and penetrates another attack target. Accordingly, the Blaster worm can be classified as an attack in which all of the penetration step S310, the operation step S320 and the next attack step S330 are executed automatically.

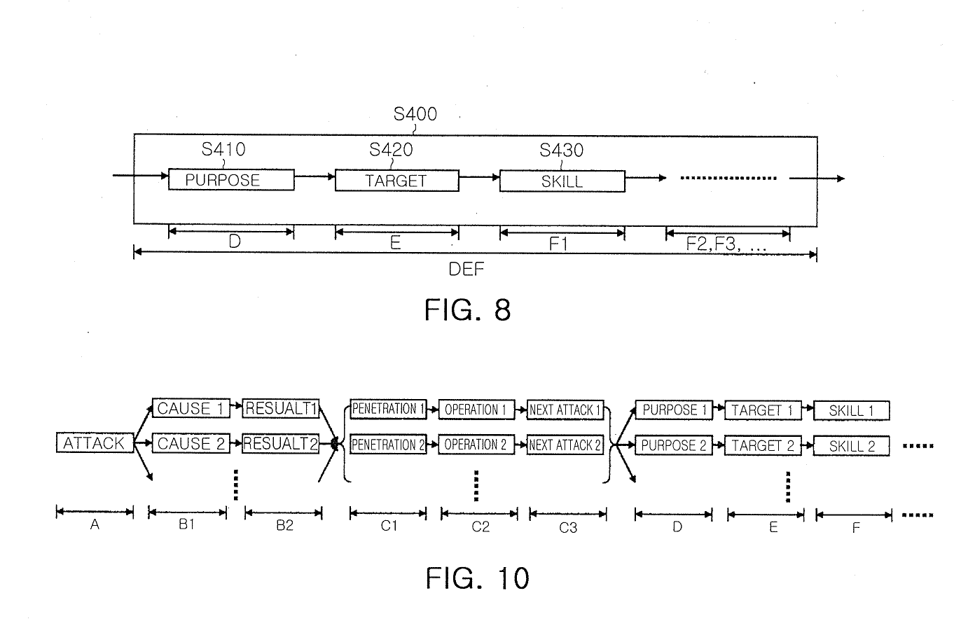

FIG. 8 is a detailed flow diagram of the classification step S400 depending on the attack intentions.

In general, an attack is generated to achieve the purpose of an attacker, and to detect the attack intention is important for detection of the purpose of the attacker. Accordingly, in the present invention, the attack intention in the classification step S400 is defined as “the attack skill F is used for the attack target E in order to achieve the attack purpose D”. The attack purpose refers to malicious results that are generated by the attack of the attacker, examples of which are to steal information on a system and to down the system. The attack target refers to a location where the malicious results are generated or more detailed malicious results, which can be interpreted as obtainment of information on a network or disturbance of an application service of a host. The attack skill refers to an attack skill for achievement of the attack purpose.

Accordingly, the classification step S400 depending on the attack intentions may comprise a step S410 of detecting the attack purpose D, a step S420 of detecting the attack target E, and a step S430 of detecting the attack skill F, example of which are network protocol and port number.

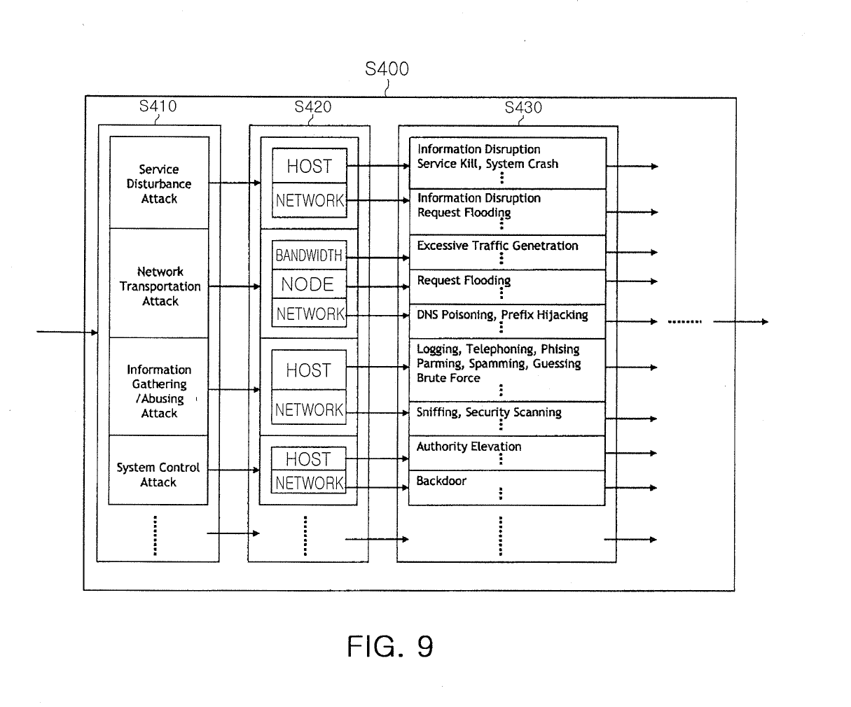

FIG. 9 illustrates the detailed items of each classification step (S410, S420, and S430) of the classification step S400 illustrated in FIG. 8. The detailed items are configured according to the attack intentions and can be easily expanded when new purpose, target and skill happen.

The attack purpose D comprises four detailed items.

1) Service Disturbance Attack: this refers to any attack that disturbs the use of resources or any service performed in a host connected to a network.

2) Network Transportation Attack: this refers to any attack that disturbs the use of systems and resources that are necessary during the transport of information on a network.

3) Information Gathering/Abusing Attack: this refers to any attack that gathers or abuses actual information transported on a network.

4) System Control Attack: this refers to an attack that enables an attacker to control an attacked system arbitrarily.

The attack target E refers to a place where malicious results are generated on a network (e.g., all components of the network), examples of which are a host, a network, a bandwidth, and a node illustrated in FIG. 9. The node refers to a system for providing a transport service over the network, examples of which are a DNS server, a router, and a switch. The service disturbance attack may be generated in a network or in a host. The network transportation attack may be targeted on the bandwidth or the node. The information gathering/abusing attack and the system control attack may be targeted on the host or the network.

The attack skill F for the attack target E may vary depending on the purpose and target of an attack and two or more attack skills may be used simultaneously. Referring to FIG. 9, examples of an attack skill used for service disturbance attack targeted on the host are an information disruption skill, a service kill skill, and a system crash skill. In the information disruption skill, the information and resource of the host are used to change or delete files out of a user s will. In the service kill skill, important operating programs are terminated forcibly. In the system crash skill, a hard disk is formatted to crash a system. Examples of an attack skill used for service disturbance attack targeted on the network are an information disruption skill and a request flooding skill. In the information disruption skill, information and resource transported on the network are abused, changed and deleted. In the request flooding skill, an excessive request is generated on the network to disturb a normal service.

The Blaster worm transports unnecessary traffic data to a port No. 135 to degrade the normal traffic transport capabilities of network transport systems. In addition, the Blaster worm changes an Internet Explorer start page of an infected host to disturb a service desired by a host user. Therefore, in the classification step S400, the Blaster worm is classified as a service disturbance attack that disturbs some services of the host and exhausts the bandwidth to disturb network transportation. Examples of an attack skill used for an attack target (the network and the host) for achievement of the above purpose are excessive traffic generation and information disruption.

FIG. 10 illustrates an example of classification of a blended type attack according to the present invention.

In general, recent attacks abuse a plurality of vulnerabilities and are generated to comprise a plurality of attack intentions. The attack classification method according to the present invention makes it possible to represent the blended type attacks very effectively.

The attack classification method according to the present invention classifies one attack depending on the cause and result of vulnerability, a skill of propagation (penetration-operation-next attack), the intention, purpose and target of the attack, and an attack skill. The classification results are arranged in the order of a vulnerability cause B1, a corresponding result B2 caused by the vulnerability cause B1, a penetration skill C1 of penetration, an operation-after-penetration skill C2, a penetration skill C3 for a next attack, an attack purpose D, an attack target E, and an attack skill.

When the blended type attack is classified depending on the cause and result of vulnerability, the skill of propagation (penetration-operation-next attack), the intention, purpose and target of the attack, and the attack skill, there may be two or more corresponding features.

In the present invention, several features classified in the same classification step are arranged in parallel in the corresponding step.

That is, as illustrated in FIG. 10, the features corresponding to one attack are arranged in parallel in accordance with each of the cause and result of vulnerability, the propagation skill, the attack purpose, and the attack target, the attack skill, and the related features are connected with arrows in the order of the cause and result of vulnerability, the propagation skill, the attack purpose, and the attack target, the attack skill, thereby making it possible to detect the total flow of the attack intuitively.

Accordingly, a method and a time point for counteracting the attack can be intuitively detected using the classification results. The time point for counteracting the attack is a point (i.e., an arrow portion) between attack processes. The method for counteracting the attack refers to a defense method according to an attack feature classified in a previous stage of a corresponding arrow.

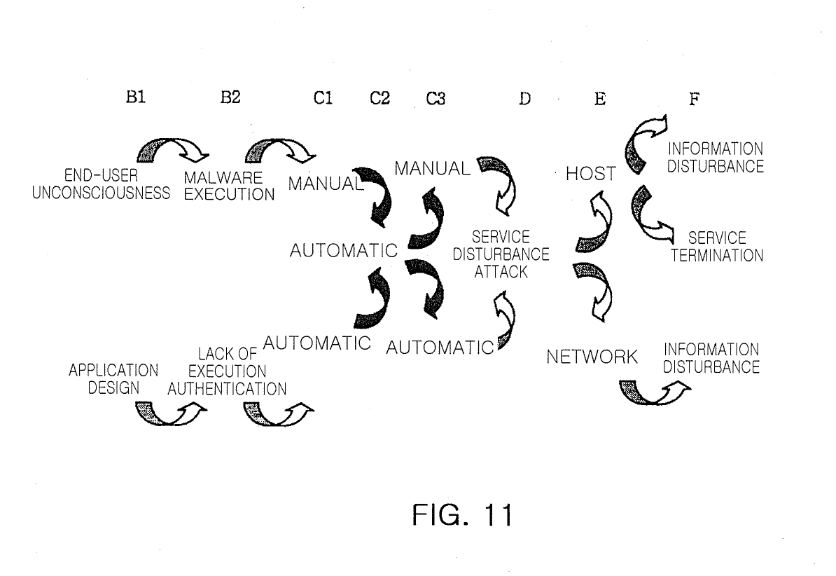

FIG. 11 illustrates the results of classification of spywares using the attack classification method according to the present invention.

A spyware is a typical example of a blended type attack that is diverse in success path and thus is very difficult to block. FIG. 11 illustrates Win-Spyware/Look2Me among known spywares.

The Win-Spyware/Look2Me has the following features.

1) The Win-Spyware/Look2Me is distributed by approval of installation of an ActiveX program at an unspecified website and is executed simultaneously with the installation approval.

2) The Win-Spyware/Look2Me may be automatically installed and executed by another spyware, and determination of a host, execution of a code and selection of a next target host are all performed automatically.

3) The Win-Spyware/Look2Me changes a start page of the Internet Explorer.

4) The Win-Spyware/Look2Me changes a host file of the Window to interrupt an access to a competitive site.

5) The Win-Spyware/Look2Me automatically executes a popup advertisement downloaded from a predetermined site every five minutes.

6) The Win-Spyware/Look2Me terminates some security-related system monitoring processes.

According to the steps S200 through S400 of the attack classification method of the present invention, the Win-Spyware/Look2Me can be classified as having attack features illustrated in Table 1 below.

TABLE 1

| Classification | Cause B1 | End-user | Design problem |
|---|---|---|---|
| according to | | unconsciousness | of application |
| vulnerability | | | program |
| | result B2 | Malware | Vulnerability |
| | | execution | of |
| | | | installation |
| | | | approval |
| Classification | Penetration | Manual | Automatic |
| according to | C1 | | |
| propagation | Operation | Automatic | |
| skill | C2 | | |
| | Next attack | Manual | Automatic |
| | C3 | | |
| | Purpose D | Service denial attack | |
| Classification | Purpose D | Service denial attack | |
| according to | Attack | Host | Network |
| attack | target E | | |
| intentions | Attack | Disturbance of | Disturbance of |
| | skill F | information | information |
| | | Termination of | |
| | | service | |

The results classified as Table 1 can be arranged according to an attack flow in the order of vulnerability, propagation skill and attack intention, which is illustrated in FIG. 11.

When going along arrows in FIG. 11, it is possible to detect the attack flow of Win-Spyware/Look2Me.

As set forth above, the embodiment of the present invention makes it possible to provide an attack classification method for easily detecting the features of all attacks related to computers and network. The attack classification method according to the present invention makes it possible to obtain information for detecting the attack feature of “the attack A propagates in the propagation skill C using the vulnerability B and the attack skill F is used for the attack target E to achieve the attack purpose D”. Because the overall attack flow can be detected easily, it is convenient to deduce the defense point and method for an attack.

Further, the use of the attack classification method according to the present invention makes it possible to precisely define the range and feature of an attack for design of a corresponding security system.

Furthermore, the embodiment of the present invention makes it possible to easily expand the detailed classification items while maintaining the standard classification structure and to classify not only the blended-type attacks but also new-type attacks.

Moreover, the embodiment of the present invention provides a method for systematically classifying any attack, thereby making it possible to provide the general terminology of the attack feature and flow that can be used by persons related to the computer security technology.

While the present invention has been shown and described in connection with the preferred embodiments, it will be apparent to those skilled in the art that modifications and variations can be made without departing from the spirit and scope of the invention as defined by the appended claims.

What is claimed is:

1. An attack classification method for computer network security, the method comprising the operations of:
receiving data determined to be an attack;
classifying the received attack depending on vulnerability abused by an attack;
classifying the received attack depending on attack propagation skills;
classifying the received attack depending on attack intentions;
arranging the classification results in the order of the vulnerability abused by an attack, the attack propagation skills, and the attack intentions; and
outputting the arranged classification results.

2. The attack classification method according to claim 1, wherein, in the arranging the classification results, when there are at least two classification results in each of the classifying operations, the at least two classification results are arranged in parallel.

3. The attack classification method according to claim 2, wherein the classifying the received attack depending on attack intentions comprises:
classifying an attack purpose of a corresponding attack;
classifying an attack target of the corresponding attack; and
classifying an attack skill used to achieve the attack purpose in the classified attack target.

4. The attack classification method according to claim 3, wherein, in the arranging the classification results, the classification results are arranged in the order of a vulnerability, a propagation skill, an attack purpose, an attack target, and an attack skill and connects the arranged classification results in order using arrows, in order to be able to detect an attack flow where an attack propagates in the propagation skill using the vulnerability and the attack skill is used for the attack target to achieve the attack purpose D.

5. The attack classification method according to claim 4, wherein the attack purpose comprises one or more of a service disturbance attack that disturbs the use of resources or any service performed in a host connected to a network, a network transportation attack that disturbs the use of systems and resources that are necessary during the transport of information on a network, an information gathering/abusing attack that gathers or abuses actual information transported on a network, and a system control attack that enables an attacker to control an attacked system arbitrarily.

6. The attack classification method according to claim 5, wherein the target of the service disturbance attack comprises one or more of an application service of a host connected to a network and a network service provided by the network host.

7. The attack classification method according to claim 5, wherein the target of the network transportation attack comprises one or more of a bandwidth between paths used by a network transport system, a node on a network transport path for providing a network transportation service, and information necessary for network transportation.

8. The attack classification method according to claim 5, wherein the target of the information gathering/abusing attack comprises one or more of information on a host system connected to a network, and information transported on a network.

9. The attack classification method according to claim 5, wherein the target of the system control attack comprises one or more of a system connected to a host and a system connected to a network.

10. The attack classification method according to claim 4, wherein the classifying the received attack depending on vulnerability abused by an attack comprises classifying a corresponding attack depending on the cause of the vulnerability and classifying the corresponding attack depending on a vulnerable result caused by the classified cause, and the step of arranging the classification results arranges the vulnerability classification results in the order of cause and vulnerable result.

11. The attack classification method according to claim 10, wherein the cause of the vulnerability comprises:
a code vulnerability generated in a system using a vulnerable code due to a mistake or lack of consciousness of a designer;
a configuration vulnerability generated when an OS, an application or a network is set incorrectly;
an application design vulnerability generated when the execution results of an application program cause a security problem regardless of whether a function is designed intentionally;
a network protocol design vulnerability generated due to the design problem of a network protocol; and
an end-user unconsciousness vulnerability caused by a lack of a user's security consciousness.

12. The attack classification method according to claim 11, wherein the vulnerable result caused by the code vulnerability comprises a buffer overflow and a format string.

13. The attack classification method according to claim 11, wherein the vulnerable result caused by the configuration vulnerability comprises incorrect authentication and incorrect network configuration.

14. The attack classification method according to claim 11, wherein the vulnerable result caused by the application design vulnerability comprises one or more of arbitrary command execution, arbitrary information access, careless information leakage, and lack of execution authentication, the arbitrary command execution being to the arbitrary execution of a shell command without a user's consent, the arbitrary information access being the arbitrary access of files or system information without a user's consent, the careless information leakage being the careless leakage of important information due to the problem of a program design, the lack of execution authentication being the execution of a program without a user's consent.

15. The attack classification method according to claim 11, wherein the vulnerable result caused by the network protocol design vulnerability comprises one or more of lack of confidentiality, lack of integrity, and lack of authentication, the lack of confidentiality being the leakage of information due to non-encrypted information, the lack of integrity being the impossibility of detection of whether normal information is arbitrary changed by an attacker, the lack of authentication being generated because there is no authentication method for confidence in a communication opponent party.

16. The attack classification method according to claim 11, wherein the vulnerable result caused by the end-user unconsciousness comprises one or more of malware execution and vulnerable password.

17. The attack classification method according to claim 4, wherein the second classification step classifies the received attack depending on whether attack propagation is manually executed with the intervention of a user or is automatically executed without the intervention of a user.

18. The attack classification method according to claim 17, wherein the classifying the received attack depending on attack propagation skills comprises:
determining the automaton or not of a penetration step in which the vulnerability of an attack target is used to infect the attack target;
determining the automation or not of an operation step in which an malicious action is executed in the penetrated target; and
determining the automation or not of an next attack step in which a next attack target is selected and penetrated,
wherein the step of arranging the classification results arranges the classification results depending on the propagation skill in the order of the automation or not of the penetration step, the automation or not of the operation step, and the automation or not of the next attack step.
